(19) United States
(12) Patent Application Publication
(10) Pub. No.: US 2021/0086333 A1
(43) Pub. Date: Mar. 25, 2021

(54) IMPACT ROTARY TOOL

(71) Applicant: Panasonic intellectual Property Management Co., Ltd., Osaka (JP)

(72) Inventors: Hiroaki MURAKAMI, Mie (JP); Itaru MURUl, Nara (JP); Akiko HONDA, Osaka (JP); Mitsumasa MIZUNO, Osaka (JP)

(21) Appl. No.: 17/054,436

(22) PCT Filed: Mar. 20, 2019
(86) PCT No.: PCT/JP2019/011786

§ 371 Date: Nov. 10, 2020

(30) Foreign Application Priority Data
May 11, 2018 (JP) 2018-092547

(51) Int. Cl. B25B 21/02; B25B 23/147

(52) U.S. Cl. CPC B25B 21/026; B25D 17/06; B25B 23/1475

(57) ABSTRACT

An impact rotary tool includes: a driver, a spindle, an anvil disposed in front of the spindle in a rotation axis direction, a main hammer applying a rotation force to the anvil, and a sub-hammer applying, to the main hammer having applied the rotation force to the anvil, a rotation force in the same direction.

### TECHNICAL FIELD

The present disclosure relates to an impact rotary tool.

### BACKGROUND ART

Patent Literature 1 discloses an impact wrench that includes a spindle rotated by a driver, an anvil disposed in front of the spindle in a rotation axis direction, and a rotary impact mechanism for converting the rotation of the spindle into a rotary impact and transmitting it to the anvil. The rotary impact mechanism has a main hammer which is rotatable around the rotation axis of the spindle and movable in the axis direction, and a sub-hammer which the main hammer is accommodated in, the spindle is inserted into, and rotates integrally with the main hammer. The impact wrench is provided with a cam structure with steel balls disposed between a guide groove on the side of the spindle and an engagement groove on the side of the main hammer, and the main hammer repeats backward and forward movements at high speed by the cam structure to thereby give a rotation force to the anvil.

In the impact wrench disclosed in Patent Literature 1, each of the main hammer and the sub-hammer includes four grooves parallel to the rotation axis, and the grooves of the main hammer engage with a needle-like roller fitted in the grooves of the sub-hammer. By the needle-like roller, the main hammer and the sub-hammer can rotate integrally, and the main hammer can move in the axis direction along the needle-like roller.

Patent Literature 2 discloses an impact tool including an output shaft to which a rotary impact around an axis is applied by an impact mechanism, which includes a biasing mechanism for biasing the output shaft in a rotation direction even when no rotation direction impact occurs.

### PATENT LITERATURE

[Patent Literature 1] JP2014-240108

[Patent Literature 2] JP2016-175144

### SUMMARY OF THE INVENTION

### Technical Problem

Motor control of various methods is put into practical use for the purpose of torque management of electric power tools. In the impact rotary tool, shut-off control is performed to automatically stop the motor rotation when an estimated tightening torque reaches a set target torque. When a torque sensor for detecting a twisting strain of the anvil is used to estimate the tightening torque, the torque sensor needs to detect a strain amount according to an actual tightening torque in order to improve torque management accuracy.

However, there is a circumferential clearance (play) between the anvil and a tip tool and between the tip tool and a tightened member. For this reason, when the hammer has an impact on the anvil and the torque sensor detects the strain amount, the tip tool has not yet applied the tightening torque to the tightened member. After the impact by the hammer, the anvil rotates the tip tool to close the circumferential clearance, and then the tightening torque is applied to the tightened member. During this period, if the hammer cannot maintain a contact state with the anvil and moves away from the anvil, the torque sensor cannot accurately detect the strain amount of the anvil according to the actual tightening torque. Further, if the hammer moves away from the anvil before tightening with the tip tool, torque transmission efficiency by the anvil decreases, and power efficiency of the impact rotary tool decreases. Therefore, it is preferable to reduce the clearance existing between the tip tool and the tightened member before the tip tool applies the tightening torque to the tightened member.

An object of the present disclosure is to provide technology for reducing a circumferential clearance between an anvil (output shaft) and a tightened member in an impact rotary tool having a plurality of hammers.

### Solution to Problem

In order to solve the above problems, an impact rotary tool according to one aspect of the present disclosure includes a driver, a spindle rotated by the driver, an anvil disposed in front of the spindle in a rotation axis direction, a first hammer applying a rotation force to the anvil, and a second hammer applying, to the first hammer having applied the rotation force to the anvil, a rotation force in the same direction.

### BRIEF DESCRIPTION OF DRAWINGS

FIG. 1 is a schematic cross-sectional view of a main portion of an impact rotary tool according to an embodiment.

FIG. 2(a) is a front perspective view of a main hammer, FIG. 2(b) is a perspective view of a spindle and a carrier, and FIG. 2(c) is a rear perspective view of a sub-hammer.

FIG. 3 is a diagram showing a state where the main hammer is assembled into the sub-hammer.

FIG. 4 is an enlarged view of a connection structure of the sub-hammer and the main hammer.

FIG. 5 is a diagram showing an analysis result of the behaviors of a torque estimated from a sensor detection value and an actually applied tightening torque.

### DESCRIPTION OF EMBODIMENTS

An impact rotary tool according to an embodiment includes a driver, a spindle rotated by the driver, an anvil disposed in front of the spindle in a rotation axis direction, and a rotary impact mechanism for converting the rotation of the spindle into a rotary impact and transmitting it to the anvil. The rotary impact mechanism adopts a double hammer configuration, and includes a main hammer (first hammer) applying a rotation force to the anvil and a sub-hammer (second hammer) applying, to the first hammer having applied the rotation force to the anvil, a rotation force in the same direction. The double hammer configuration according to the embodiment has a mechanism where the main hammer and the sub-hammer are connected in a circumferential direction by a connection structure, and when the main hammer rotates, the sub-hammer follows and rotates. However, the double hammer configuration may adopt a mechanism where the main hammer and the sub-hammer rotate independently.

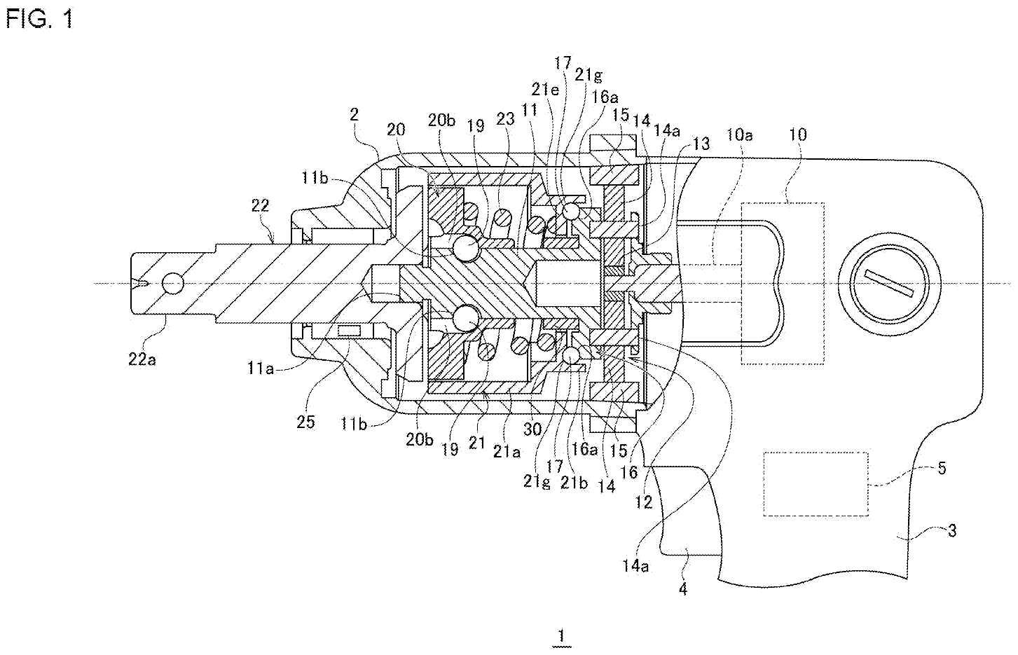

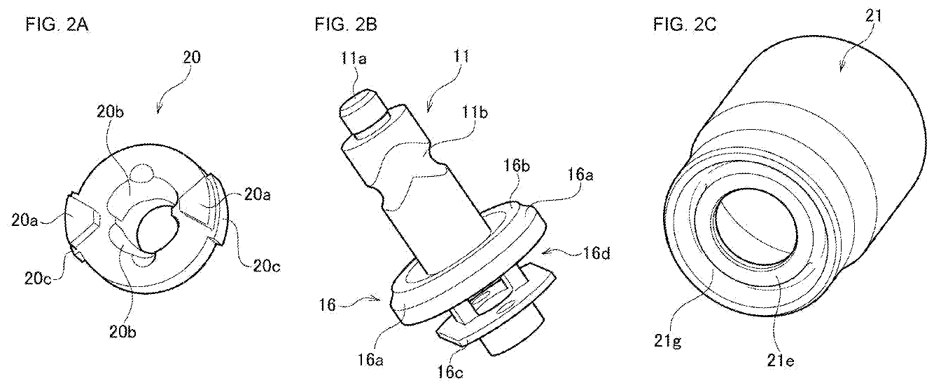

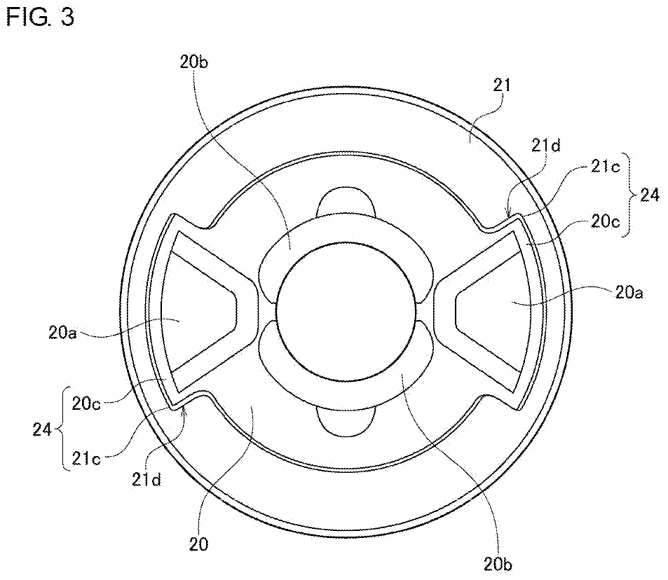

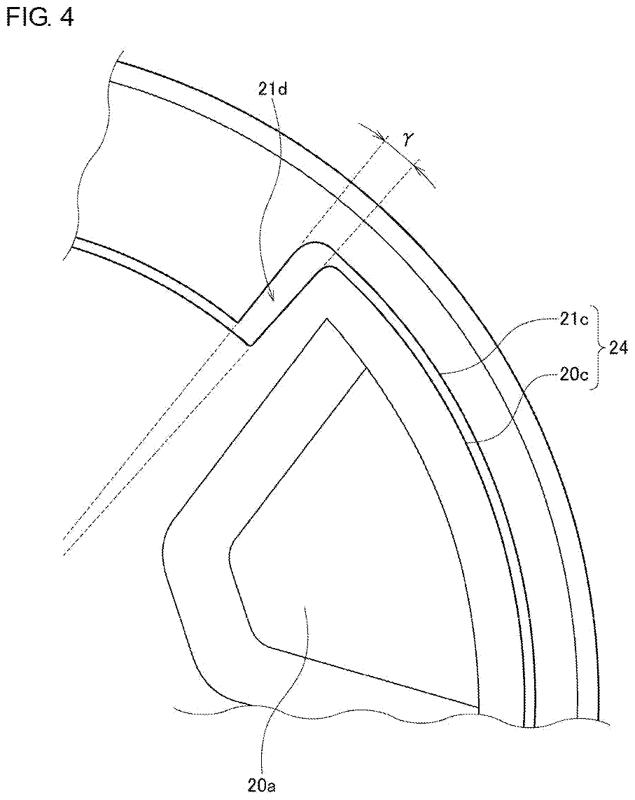

FIG. 1 shows a schematic cross-sectional view of a main portion of the impact rotary tool according to the embodiment. In FIG. 1, an alternate long and short dash line shows a rotation axis in an impact rotary tool 1. FIG. 2(a) shows a front perspective view of a main hammer, FIG. 2(b) shows a perspective view of a spindle and a carrier, and FIG. 2(c) shows a rear perspective view of a sub-hammer. FIG. 3 shows a state where the main hammer is assembled into the sub-hammer. FIG. 4 shows an enlarged view of a connection structure of the sub-hammer and the main hammer. Hereinafter, a structure of the impact rotary tool 1 will be described using FIGS. 1 to 4.

The impact rotary tool 1 includes a housing 2 that configures a tool body. An upper portion of the housing 2 forms an accommodation space for accommodating various components, and a lower portion of the housing 2 configures a grip portion 3 to be gripped by a user. An operation switch 4 operated by a user's finger is provided on the front side of the grip portion 3, and a battery (not shown) supplying electric power to a driver 10 is provided at a lower end of the grip portion 3.

The driver 10 is an electric power motor, and a drive shaft 10a of the driver 10 is connected to a carrier 16 and a spindle 11 via a power transmission mechanism 12. The carrier 16 is located on the side of a rear end of the spindle 11 and accommodates a gear for power transmission. Referring to FIG. 2(b), the carrier 16 is configured as a large diameter portion having an outer diameter larger than that of the spindle 11. The carrier 16 has a front member 16b having a diameter larger than that of the spindle 11 and a rear member 16c located on the rear side of the front member 16b, and forms a space 16d for accommodating the gear between the front member 16b and the rear member 16c.

The power transmission mechanism 12 has a sun gear 13 press-fitted and fixed to a tip of the drive shaft 10a, two planet gears 14 engaging with the sun gear 13, and internal gears 15 engaging with the planet gears 14. The planet gear 14 is rotatably supported by a support shaft 14a fixed to the front member 16b and the rear member 16c, in a space 16d of the carrier 16. The internal gear 15 is fixed to an inner circumferential surface of the housing 2.

By the power transmission mechanism 12 configured as described above, the rotation of the drive shaft 10a is decelerated on the basis of a ratio of the number of teeth of the sun gear 13 and the number of teeth of the internal gear 15, and a rotation torque is increased. This allows the carrier 16 and the spindle 11 to be driven at low speed and high torque.

The rotary impact mechanism of the impact rotary tool 1 includes the spindle 11, the carrier 16, a main hammer 20, a sub-hammer 21, and a spring member 23. The spindle 11 is formed in a columnar shape, and a small-diameter protrusion 11a is formed at the tip thereof coaxially with the axis of the spindle 11. The protrusion 11a is rotatably inserted into a hole having a columnar internal space formed in the rear portion of the anvil 22.

The steel main hammer 20 having a substantially disk shape and having a through-hole formed in a center is mounted on the outer circumference of the spindle 11. A pair of hammer claws 20a protruding toward the anvil 22 is formed on a front surface of the main hammer 20. The main hammer 20 is attached to the spindle 11 so as to be rotatable around the rotation axis of the spindle 11 and movable in the rotation axis direction of the spindle 11, that is, a front-back direction. This allows the main hammer 20 to apply a rotation force to the anvil 22. The sub-hammer 21 is formed as a steel cylindrical member, and is partitioned into a front portion 21a and a rear portion 21b by an annular partition portion 21e. The sub-hammer 21 accommodates the main hammer 20 in an internal space of the front portion 21a.

Referring to FIGS. 3 and 4, the sub-hammer 21 and the main hammer 20 are circumferentially connected by a connection structure 24. In the embodiment, the connection structure 24 has a structure in which arcuate convex portions 20c convexly provided on the outer circumferential surface of the main hammer 20 and arcuate concave portions 21c concavely provided on the inner circumferential surface of the sub-hammer 21 are loosely fitted. With this structure, when the main hammer 20 rotates, an end of the convex portion 20c on the rotation direction side applies a rotation force to an end of the concave portion 21c on the rotation direction side, and the sub-hammer 21 rotates following the main hammer 20 around the rotation axis of the spindle 11.

The main hammer 20 can move in the front-back direction with respect to the sub-hammer 21 by using the connection structure 24 as a guide. In the example shown in FIG. 3, the two convex portions 20c are formed on the outer circumferential surface of the main hammer 20 and the two concave portions 21c are formed on the inner circumferential surface of the sub-hammer 21. However, three or more convex portions 20c and concave portions 21c may be formed in a loosely fit arrangement.

A center angle β of the arcuate concave portion 21c is larger than a center angle α of the arcuate convex portion 20c. By designing the concave portion 21c and the convex portion 20c so that the center angle β >the center angle α is realized, the main hammer 20 is connected to the sub-hammer 21 with a circumferential clearance 21d. As shown in FIG. 4, the circumferential angle clearance in the connection structure 24 is γ (=β−α), and the plurality of connection structures 24 are designed to have the same clearance.

The main hammer 20 is connected to the sub-hammer 21 by the connection structure having the circumferential clearance 21d (angle γ), so that timing at which the sub-hammer 21 generates a rotary impact force can be delayed by an angle γ from timing at which the main hammer 20 generates the rotation impact force. This action will be described later.

In the example shown in FIGS. 3 and 4, the connection structure 24 is formed to have the arcuate convex portion 20c of the main hammer 20 and the arcuate concave portion 21c of the sub-hammer 21. In another example, the connection structure 24 may be a structure in which arcuate concave portions concavely provided on the outer circumferential surface of the main hammer 20 and arcuate convex portions convexly provided on the inner circumferential surface of the sub-hammer 21 are loosely fitted.

The spring member 23 is interposed between the rear portion of the main hammer 20 and the annular partition portion 21e of the sub-hammer 21. The main hammer 20 can move in the front-back direction by using the connection structure 24 as a guide, and a rotation impact force can be applied to the anvil 22 by a biasing force of the spring member 23.

The spindle 11 includes two guide grooves 11b on its outer circumferential surface, and the main hammer 20 includes two engagement grooves 20b on an inner circumferential surface of the through-hole. The two guide grooves 11b have the same shape and are disposed side by side in the circumferential direction, and the two engagement grooves 20b have the same shape and are disposed side by side in the circumferential direction. Steel balls 19 are disposed between the guide grooves 11b and the engagement grooves 20b in a state where the main hammer 20 is mounted on the outer circumference of the spindle 11. The guide groove 11b on the side of the spindle 11, the engagement groove 20b on the side of the main hammer 20, and the steel ball 19 disposed between both the grooves form a “cam structure”. The two steel balls 19 support the main hammer 20 in the radial direction so that the main hammer 20 can rotate around the rotation axis of the spindle 11 and can move in the rotation axis direction.

In the cam structure, the guide groove 11b is formed in a V shape or a U shape when viewed from the side of the tool tip. That is, the guide groove 11b has two inclined grooves that are symmetrically inclined in a rearward oblique direction from a foremost portion. The engagement groove 20b is formed in a V shape or a U shape in an opposite direction when viewed from the side of the tool tip. When the steel ball 19 moves from the foremost portion of the guide groove 11b along the inclined groove, the main hammer 20 moves backward relative to the spindle 11.

The sub-hammer 21 includes an annular first holding groove 21g on the rear surface of the annular partition portion 21e, and the carrier 16 has an annular second holding groove 16a on the outer circumference of the front surface of the front member 16b. A plurality of steel balls 17 are disposed in the circumferential direction between the first holding groove 21g and the second holding groove 16a without the clearance. The steel ball 17 may be formed smaller than the steel ball 19. The first holding groove 21g on the side of the sub-hammer 21, the second holding groove 16a on the side of the carrier 16, and the steel ball 17 disposed without the clearance between both the grooves form a “sub-hammer support structure”. In the sub-hammer support structure, the steel ball 17 is disposed between the sub-hammer 21 and the carrier 16 so as to receive a load in a direction different from the rotation axis direction of the spindle 11 and the radial direction orthogonal to the rotation axis direction.

A stopper member 30 is provided between the main hammer 20 and the carrier 16, and regulates a movement range of the main hammer 20 in the rotation axis direction so that the steel ball 19 in the cam structure does not collide with an end of the inclined groove. The stopper member 30 may be formed of, for example, a resin material.

The anvil 22 that engages with the main hammer 20 is made of steel, and is rotatably supported by the housing 2 via a slide bearing made of steel or brass. The tip of the anvil 22 is provided with a tool mounting portion 22a having a quadrangular cross-section for mounting a tip tool to be mounted on a head of a hexagon bolt or a hexagon nut.

The rear portion of the anvil 22 is provided with a pair of anvil claws that engage with the pair of hammer claws 20a of the main hammer 20. Each of the pair of anvil claws is formed as a columnar member having a fan-shaped cross section. The number of each of the anvil claws of the anvil 22 and the hammer claws 20a of the main hammer 20 does not necessarily have to be two, and if the number of the respective claws is equal, three or more claws may be provided at equal intervals in the circumferential direction of the anvil 22 and the main hammer 20.

The impact rotary tool 1 includes a torque sensor 25 that detects the torque of the anvil 22. The torque sensor 25 may be, for example, a magnetostrictive strain sensor that detects the twisting strain of the anvil 22 to be the output shaft. The magnetostrictive strain sensor detects a change in magnetic permeability according to the strain of the shaft caused by the torque applied to the anvil 22 with a coil installed in a non-rotation portion, and outputs a voltage signal according to the strain.

A control unit 5 controls the operation of the entire tool. The control unit 5 estimates the tightening torque by using detection values of the torque sensor 25 and a rotation angle sensor (not shown) of the anvil 22, and performs shut-off control that automatically stops the rotation of the driver 10 when the estimated tightening torque reaches a set target torque. In order to manage the tightening torque with high accuracy, the torque sensor 25 needs to detect a strain amount according to the actual tightening torque.

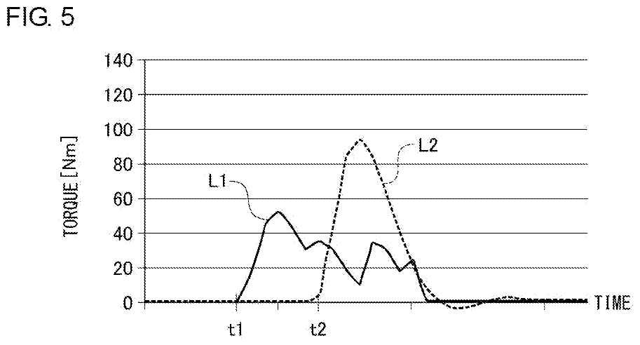

FIG. 5 shows an analysis result of the behaviors of the torque estimated from the sensor detection value and the tightening torque actually applied to the bolt to be the tightened member, in the conventional impact rotary tool. A line L1 shows the behavior of the tightening torque estimated on the basis of the detection value of the torque sensor, and a line L2 shows the behavior of the tightening torque actually applied to the bolt by the tip tool.

According to the analysis result, in the line L1, at the time t1, the hammer has an impact on the anvil, and the torque sensor 25 detects the twisting strain of the anvil. The anvil closes the circumferential clearance existing between the bolt and the anvil during a period from the time t1 to the time t2. As a result, in the line L2, the actual tightening torque is applied to the bolt at the time t2.

If the hammer maintains the contact state with the anvil during the period from the time t1 to the time t2, when the tightening torque is applied to the bolt at the time t2, the torque sensor 25 detects the strain amount according to the tightening torque applied to the bolt, and the control unit can perform the shut-off control for realizing the torque management with high accuracy. However, if the hammer receives a repulsive force from the anvil and moves away, during the period from the time t1 to the time t2, the torque sensor 25 detects a small strain amount with respect to the actual tightening torque, which causes deterioration of torque management accuracy.

Therefore, in the impact rotary tool 1 according to the embodiment, in the double hammer configuration of the main hammer 20 and the sub-hammer 21, the main hammer 20 and the sub-hammer 21 are connected by the connection structure 24 having the circumferential clearance 21d. As a result, in the impact rotary tool 1, a configuration in which, after the main hammer 20 has an impact on the anvil 22 to reduce (ideally eliminate) the circumferential clearance between the anvil 22 and the bolt, the sub-hammer 21 has an impact on the main hammer 20 is realized. With this configuration, power efficiency of the impact rotary tool 1 is improved, and the torque sensor 25 can accurately detect the strain amount of the anvil 22 according to the tightening torque.

The clearance 21d of the connection structure 24 is provided to cause the sub-hammer 21 to be slightly delayed from the main hammer 20 so as to follow and rotate. Referring to FIGS. 3 and 4, when the main hammer 20 rotates, the end of the convex portion 20c on the side of the rotation direction contacts the end of the concave portion 21c of the sub-hammer 21 on the side of the rotation direction to apply a rotation force, and the sub-hammer 21 rotates together with the main hammer 20. In this state, the hammer claw 20a of the main hammer 20 has an impact on the anvil claw of the anvil 22 (hereinafter, referred to as a “first impact”) to apply the rotation force to the anvil 22. At this time, since the sub-hammer 21 is loosely fitted in the main hammer 20, the rotation force is not applied. After the first impact, when the sub-hammer 21 is rotated by the angle γ to be the clearance 21d of the connection structure 24 due to inertia, the end of the concave portion 21c on the side opposite to the rotation direction has an impact on the end of the convex portion 20c of the main hammer 20 on the side opposite to the rotation direction (hereinafter, referred to as “second impact”) to apply the rotation force to the main hammer 20.

In the bolt tightening work, a worker pulls the operation switch 4 to a maximum amount in a movable range. When the operation switch 4 is pulled, the control unit 5 rotates the driver 10, which is a motor, at a predetermined rotation speed. In the embodiment, the clearance 21d in the connection structure 24 is determined according to a motor rotation speed during the tightening work, and the magnitude (angle γ) of the clearance 21d is set so that the second impact occurs after a predetermined time from the first impact.

The predetermined time from the first impact is defined as a time for which the circumferential clearance between the anvil 22 and the bolt can be sufficiently reduced by the first impact. For example, the predetermined time may be defined as a time for which the circumferential clearance can be reduced to half or less. Further, the predetermined time may be defined as a time for which the circumferential clearance can be reduced to ¼ or less. After sufficiently reducing the circumferential clearance by the first impact, the rotation force of the sub-hammer 21 is transmitted to the anvil 22 via the main hammer 20 by the second impact, so that highly accurate torque management can be realized.

The clearance 21d is preferably set so that the sub-hammer 21 has an impact on the main hammer 20 in contact with the anvil 22. That is, the clearance 21d is designed so that the sub-hammer 21 can apply the rotation force to the main hammer 20, before the main hammer 20 moves away from the anvil 22. As a result, power efficiency of the impact rotary tool 1 can be improved, and highly accurate torque management can be realized.

The present disclosure has been described on the basis of the embodiment. The embodiment is merely an example, and it is understood by those skilled in the art that various modifications can be made in the combination of the respective components or the respective processes, and that the modifications are also within the scope of the present disclosure. In the embodiment, although the torque sensor 25 detects the torque of the anvil 22, it may detect the torque of the main hammer 20. Further, in the embodiment, although the rotary impact mechanism has the double hammer configuration, it may have a configuration with three or more hammers.

An outline of an aspect of the present disclosure is as follows.

An impact rotary tool (1) according to one aspect of the present disclosure includes a driver (10); a spindle (11) rotated by the driver (10); an anvil (22) disposed in front of the spindle (11) in a rotation axis direction; a first hammer (20) applying a rotation force to the anvil (22); and a second hammer (21) applying, to the first hammer (20) having applied the rotation force to the anvil (22), a rotation force in the same direction.

In the impact rotary tool (1), after the first hammer (20) has an impact on the anvil (22) to reduce a circumferential clearance between the anvil (22) and a tightened member, the second hammer (21) may have an impact on the first hammer (20). The second hammer (21) preferably has an impact on the first hammer (20) in contact with the anvil (22).

The first hammer (20) may be rotatable around a rotation axis of the spindle (11) and movable in the rotation axis direction. The first hammer (20) may be connected to the second hammer (21) by a connection structure (24) having a circumferential clearance (21d). The second hammer (21) may have an internal space for accommodating the first hammer (20), and the connection structure (24) may be a structure in which a convex portion (20c) or a concave portion provided on an outer circumferential surface of the first hammer and a concave portion (21c) or a convex portion provided on an inner circumferential surface of the second hammer are loosely fitted.

The clearance (21d) is preferably set so that the second hammer (21) has an impact on the first hammer (20) after a predetermined time elapses from when the first hammer has an impact on the anvil (22). The impact rotary tool (1) may include a torque sensor (25) detecting a torque of the anvil (22) or the first hammer (20).

### REFERENCE SIGNS LIST

1 impact rotary tool, 10 driver, 11 spindle, 20 main hammer, 20c convex portion, 21 sub-hammer, 21c concave portion, 21d clearance, 22 anvil, 24 connection structure, 25 torque sensor

### INDUSTRIAL APPLICABILITY

The present disclosure can be used in the field of impact rotary tools.

1. An impact rotary tool comprising:
a driver;
a spindle rotated by the driver;
an anvil disposed in front of the spindle in a rotation axis direction;
a first hammer structured to apply a rotation force to the anvil; and
a second hammer structured to apply, to the first hammer having applied the rotation force to the anvil, a rotation force in the same direction.

2. The impact rotary tool according to claim 1, wherein
after the first hammer has an impact on the anvil to reduce a circumferential clearance between the anvil and a tightened member, the: second hammer has an impact on the first hammer.

3. The impact rotary tool according to claim 1, wherein
the second hammer has an impact on the first hammer in contact with the anvil.

4. The impact rotary tool according to claim 1, wherein
the first hammer is rotatable around a rotation axis of the spindle and is movable in the rotation axis direction, and
the first hammer is connected to the second hammer by a connection structure having a circumferential clearance.

5. The impact rotary tool according to claim 4, wherein
the second hammer has an internal space for accommodating the first hammer, and
the connection structure is a structure in which a convex portion or a concave portion provided on an outer circumferential surface of the first hammer and a concave portion or a convex portion provided on an inner circumferential surface of the second hammer are loosely fitted.

6. The impact rotary tool according to claim 4, wherein
the clearance is set so that the second hammer has an impact on the first hammer after a predetermined time elapses from when the first hammer has an impact on the anvil.

7. The impact rotary tool according to claim 1, further comprising:
a torque sensor structured to detect a torque of the anvil or the first hammer.

8. The impact rotary tool according to claim 2, wherein
the second hammer has an impact on the first hammer in contact with the anvil.

9. The impact rotary tool according to claim 5, wherein
the clearance is set so that the second hammer has an impact on the first hammer after a predetermined time elapses from when the first hammer has an impact on the anvil.
